(19) United States
(12) Patent Application Publication
(10) Pub. No.: US 2012/0088658 A1
(43) Pub. Date: Apr. 12, 2012

(54) Composition comprising a pesticide and a polycarboxylate ether

(76) Inventors: Torsten KNIERIEM, Mannheim (DE); Charles W. FINCH, Garner, NC (US); Claudia KLODWIG, Hessheim (DE); Silke FLAKUS, Ebersberg (DE); Gerhard ALBRECHT, Prien a. Chiemsee (DE)

(21) Appl. No.: 13/268,275

(22) Filed: Oct. 7, 2011

Related U.S. Application Data
(60) Provisional application No. 61/391,698, filed on Oct. 11, 2010.

(30) Foreign Application Priority Data
Oct. 25, 2010 (EP) 10188735.4
Feb. 3, 2011 (EP) 11153229.7

(51) Int. Cl. A01N 25/10; A01N 25/02; B05D 3/02; A01P 7/04; A01C 1/06; A01N 25/00; A01P 3/00

(52) U.S. Cl. 504/100; 514/772.6; 514/772.4; 514/772.5; 424/408; 504/360; 427/372.2

(57) ABSTRACT

The present invention provides a composition comprising a pesticide having a solubility in water of at most 10 g/l and a polycarboxylate ether based on a) component groups of the formula Ia and/or Ib and/or Ic as defined below, and b) component groups of the general formula Il as defined below. The present invention further provides a process for producing the composition. The invention further relates to a method of controlling phytopathogenic fungi and/or unwanted plant growth and/or unwanted insect or mite infestation and/or of regulating the growth of plants, wherein the composition is allowed to act on the particular pests, the surroundings thereof or the plants to be protected from the particular pest, the soil and/or on unwanted plants and/or the crop plants and/or the surroundings thereof. The invention also relates to seed comprising the composition.

The present invention provides a composition comprising a pesticide having a solubility in water of at most 10 g/l and a polycarboxylate ether based on a) component groups of the formula Ia and/or Ib and/or Ic as defined below, and b) component groups of the general formula II as defined below. The present invention further provides a process for producing the composition by contacting the pesticide and the polycarboxylate ether. The invention further relates to a method of controlling phytopathogenic fungi and/or unwanted plant growth and/or unwanted insect or mite infestation and/or of regulating the growth of plants, wherein the composition is allowed to act on the particular pests, the surroundings thereof or the plants to be protected from the particular pest, the soil and/or on unwanted plants and/or the crop plants and/or the surroundings thereof. The invention also relates to seed comprising the composition. Combinations of preferred features with other preferred features are encompassed by the present invention.

Agrochemical formulations comprising vinyl ethers are common knowledge:

WO 2006/000592 discloses the use of amphiphilic polymers comprising polyether groups as solubilizers, said polymers comprising a hydrophobic monomer (such as styrene), an allyl alcohol alkoxylate, and optionally ethylenically unsaturated mono- or dicarboxylic acids.

WO 2009/007328 discloses the use of copolymers based on (meth)acrylic acid and nonionic monomers (such as vinyl ethers) for stabilization of sparingly water-soluble active ingredients.

WO 2003/043420 discloses the use of a copolymer based on an olefin and/or a vinyl ether and on an ethylenically unsaturated dicarboxylic acid, as an adjuvant in the treatment of plants.

A disadvantage of the known polymers is that allyl ethers are difficult to polymerize as comonomers, and high molar masses of the polymers are difficult to achieve.

It was an object of the invention to find a means by which a high dispersion stability can be achieved only with relatively small amounts of dispersant. This is especially true of formulations which comprise high concentrations of pesticide. The dispersant should also stabilize highly concentrated solid formulations after dilution with water. In the case of suspensions (in particular suspension concentrates), small added amounts of dispersant should reduce serum formation, and increase storage stability. In addition, the dispersant should be easily obtainable. It was a further object of the present invention for the dispersant also to be usable in the dressing of seed with pesticides, for example in order to achieve a high loading of the dressing material with active ingredient.

The object was achieved by a composition comprising a pesticide having a solubility in water of at most 10 g/l and a polycarboxylate ether based on a) component groups of the formula Ia and/or Ib and/or Ic as defined below, and b) component groups of the general formula II as defined below.

Suitable polycarboxylate ethers (also referred to hereinafter as “PCE”) are polymers based on
a) component groups of the formula Ia and/or Ib and/or Ic

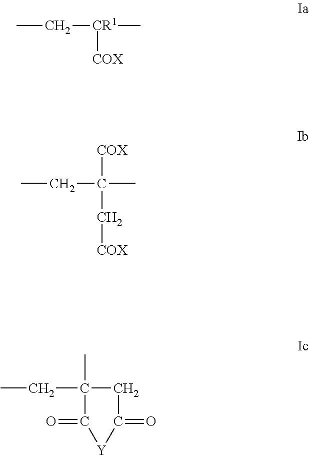

where R¹=hydrogen or an aliphatic hydrocarbon radical having 1 to 20 carbon atoms,
   X═—OMₐ, —O—(CₘH₂ₘO)ₙ—R², —NH—(CₘH₂ₘO)ₙR^{2,}
   M=hydrogen, a mono- or divalent metal cation, an ammonium ion, an organic amine radical,
   a=½ or 1,
   R²=hydrogen, an aliphatic hydrocarbon radical having 1 to 20 carbon atoms, a cycloaliphatic hydrocarbon radical having 5 to 8 carbon atoms, an optionally substituted aryl radical having 6 to 14 carbon atoms,
   Y═O, NR²,
   m=2 to 4, and
   n=0 to 200,
and
b) component groups of the general formula II

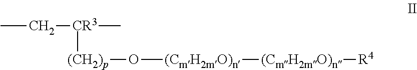

where R³=hydrogen or an aliphatic hydrocarbon radical having 1 to 5 carbon atoms,
   n′,n″=each independently 0 to 200,
   m′,m″=each independently 2 to 4,
   n′+n″=1 to 200,
   p=0 to 3, and
   R⁴=hydrogen, an aliphatic hydrocarbon radical having 1 to 20 carbon atoms, a cycloaliphatic hydrocarbon radical having 5 to 8 carbon atoms, an optionally substituted aryl radical having 6 to 14 carbon atoms.

The copolymers according to the present invention comprise at least 2 component groups, a) and b). Optionally, component groups c) and d) may additionally be present.

The first component group a) is a mono- or dicarboxylic acid derivative having the general formula Ia, Ib or Ic. In the monocarboxylic acid derivative Ia, R¹ is hydrogen or an aliphatic hydrocarbon radical having 1 to 20 carbon atoms, preferably a methyl group. X in the structures Ia and Ib is —OₐM and/or —O—(CₘH₂ₘO)ₙ—R² or —NH—(CₘH₂ₘO)ₙ—R², where M, a, m, n and R² are each defined as follows:

M is hydrogen, a mono- or divalent metal cation, ammonium, an organic amine radical, and a=½ or 1, according to whether M is a mono- or divalent cation. M is more preferably hydrogen, a mono- or divalent metal cation, or ammonium. The organic amine radicals used are preferably substituted ammonium groups which derive from primary, secondary or tertiary C₁₋₂₀-alkylamines, C₁₋₂₀-alkanolamines, C₅₋₈-cycloalkylamines and C₈₋₁₄-arylamines. Examples of the corresponding amines are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form.

R² is hydrogen, an aliphatic hydrocarbon radical having 1 to 20 carbon atoms, a cycloaliphatic hydrocarbon radical having 5 to 8 carbon atoms, an aryl radical having 6 to 14 carbon atoms, which may optionally be substituted, m=2 to 4 and n=0 to 200. The aliphatic hydrocarbons here may be linear or branched and saturated or unsaturated. Preferred cycloalkyl radicals are considered to be cyclopentyl or cyclohexyl radicals, and preferred aryl radicals to be phenyl or naphthyl radicals, which may especially be substituted by hydroxyl, carboxylic acid or sulfonic acid groups.

Instead of or in addition to the dicarboxylic acid derivative of the formula Ib, component group a) (mono- or dicarboxylic acid derivative) may also be present in cyclic form according to formula Ic, where Y may be O (acid anhydride) or NR² (acid imide) with the above definition of R².

The second component group b) corresponds to formula II and derives from oxyalkylene glycol alkenyl ethers. R³ is in turn hydrogen or an aliphatic hydrocarbon radical which has 1 to 5 carbon atoms and may likewise be linear or branched, and also unsaturated. p may assume values from 0 to 3. The component groups of the formula II used may preferably be a polyethylene glycol monovinyl ether where p=0 and m″=2. The sum of n′+n″ is preferably 3 to 150, especially 5 to 100.

In the preferred embodiments, m=2 and/or 3 in the formulae Ia and Ib, such that the polyalkylene oxide groups derive from polyethylene oxide and/or polypropylene oxide. In a further preferred embodiment, p in the formula II is 0 or 1, i.e. the compounds are vinyl and/or alkyl polyalkoxylates.

The PCEs comprise typically 50 to 95 mol % of component groups of the formula Ia and/or Ib and/or Ic, and 5 to 50 mol % of component groups of the formula II, and optionally up to 20% by weight of comonomers.

These polymers comprise preferably 55 to 75 mol % of component groups of the formula Ia and/or Ib, 19.5 to 39.5 mol % of component groups of the formula II, and optionally up to 20 mol % of comonomers.

In a preferred embodiment, the inventive copolymers additionally comprise up to 50 mol %, especially up to 20 mol %, based on the sum of component groups a) and b), of optional comonomers. Optional comonomers may be any desired copolymerizable ethylenically unsaturated monomers. Examples are vinyl- or (meth)acrylic acid derivatives such as styrene, α-methylstyrene, vinyl acetate, vinyl propionate, ethylene, propylene, isobutene, hydroxyalkyl (meth)acrylates, acrylamide, methacrylamide, N-vinylpyrrolidone, allylsulfonic acid, methallylsulfonic acid, vinylsulfonic acid, vinylphosphonic acid, AMPS, methyl methacrylate, methyl acrylate, butyl acrylate, or allylhexyl acrylate. Preferred optional comonomers are styrene, α-methylstyrene, vinyl acetate, vinyl propionate, ethylene, propylene, isobutene, N-vinylpyrrolidone, allylsulfonic acid, methallylsulfonic acid, vinylsulfonic acid or vinylphosphonic acid. Particularly preferred optional comonomers are vinyl acetate, vinyl propionate, ethylene, propylene, isobutene, N-vinylpyrrolidone, allylsulfonic acid, methallylsulfonic acid, vinylsulfonic acid or vinylphosphonic acid. In a further particularly preferred embodiment, optional comonomers are vinyl acetate, vinyl propionate, ethylene, propylene, isobutene, hydroxyalkyl (meth)acrylates, acrylamide, methacrylamide, N-vinylpyrrolidone, allylsulfonic acid, methallylsulfonic acid, vinylsulfonic acid, vinylphosphonic acid, AMPS, methyl methacrylate, methyl acrylate, butyl acrylate, or allylhexyl acrylate.

The PCE comprises preferably at most 5 mol %, more preferably at most 1 mol % and especially at most 0.1 mol % of vinylaromatic monomers, such as those of the formula III

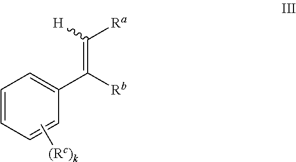

where R^{a} and R^{b} are each independently H, methyl or ethyl, R^{b} is methyl or ethyl, and k is an integer from 0 to 2. PCE is especially free of vinylaromatic monomers.

The number of repeating structural units in the copolymers is not limited. However, it has been found to be particularly advantageous to set mean molecular weights of 1000 to 100 000 g/mol.

The unsaturated mono- or dicarboxylic acid derivatives used, which form component groups a) of the formula Ia, Ib or Ic, are preferably: acrylic acid, methacrylic acid, itaconic acid, itaconic anhydride, itaconimide and itaconic monoamide.

Instead of acrylic acid, methacrylic acid, itaconic acid and itaconic monoamide, it is also possible to use the mono- or divalent metal salts thereof, preferably sodium, potassium, calcium or ammonium salts.

The acrylic, methacrylic or itaconic esters used are in particular derivatives whose alcoholic component a polyalkylene glycol of the general formula HO—(CₘH₂ₘO)ₙ—R² where R²═H, aliphatic hydrocarbon radical having 1 to 20 carbon atoms, cycloaliphatic hydrocarbon radical having 5 to 8 carbon atoms, optionally substituted aryl radical having 6 to 14 carbon atoms, and m=2 to 4 and n=0 to 200.

The preferred substituents on the aryl radical are —OH—, —COO⁻— or —SO₃_{^{−}} groups.

The unsaturated monocarboxylic acid derivatives may be present only as monoesters, whereas diester derivatives are also possible in the case of the dicarboxylic acid itaconic acid.

The derivatives of the formula Ia, Ib and Ic may also be present as a mixture of esterified and free acids, and are used in an amount of preferably 55 to 75 mol %.

The second component essential to the invention for preparation of the inventive copolymers is an oxyalkylene glycol alkenyl ether, which is used preferably in an amount of 19.5 to 39.5 mol %.

The copolymers according to the present invention can be prepared by the customary methods, for example as described in WO 2005/075529, EP 0 736 553, EP 0 894 811, or WO 2000/77058.

The composition may comprise from 0.001 to 20% by weight of PCE.

The term “active agrochemical ingredients” (also referred to hereinafter as pesticides) refers to at least one active ingredient selected from the group of the fungicides, insecticides, nematicides, herbicides, safeners and/or growth regulators. Preferred pesticides are fungicides, insecticides and herbicides, especially insecticides. It is also possible to use mixtures of pesticides from two or more of the aforementioned classes. The person skilled in the art is familiar with such pesticides, which can be found, for example, in Pesticide Manual, 15th Ed. (2009), The British Crop Protection Council, London. Suitable insecticides are insecticides from the class of the carbamates, organophosphates, organochlorine insecticides, phenylpyrazoles, pyrethroids, neonicotinoids, spinosyns, avermectins, milbemycins, juvenile hormone analogs, alkyl halides, organotin compounds, nereistoxin analogs, benzoylureas, diacylhydrazines, METI acaricides, and insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenone, or derivatives thereof. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethyl phosphonates, ethylaminothiazolecarboxamides, guanidines, hydroxy(2-amino)pyrimidines, hydroxyanilides, imidazoles, imidazolinones, inorganics, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorcarboxylic acids, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenyl carbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl (thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

The pesticide is soluble in water at 20° C. at most to an extent of 10 g/l, preferably to an extent of at most 0.5 g/l and more preferably to an extent of at most 0.1 g/l. Pyraclostrobin, for example, is water-soluble to an extent of 1.9 mg/l, prochloraz to an extent of 34 mg/L, and metrafenon to an extent of 0.5 mg/l.

The pesticide typically has a melting point of more than 30° C., preferably more than 40° C. and especially more than 45° C. The melting point of pyraclostrobin, for example, is 64° C., that of prochloraz 47° C., and that of metrafenon 100° C.

The inventive composition comprises typically 0.1 to 70% by weight of pesticide, preferably 1 to 50% by weight, especially 3 to 30% by weight, based on the composition.

The pesticide is preferably present in suspended form in the composition, i.e. in the form of crystalline or amorphous particles which are solid at 20° C. The suspended pesticide usually has a particle size distribution with an x₅₀ value of 0.1 to 10 μm, preferably of 0.2 μm to 5 μm and more preferably of 0.5 μm to 2 μm. The particle size distribution can be determined by laser light scattering of an aqueous suspension comprising the particles. In the case of this test method, the sample preparation, for example the dilution to test concentration, depends on factors including the fineness and concentration of the active ingredients in the suspension sample, and on the test system used (e.g. Malvern Mastersizer). The procedure has to be developed for the particular system and is known to those skilled in the art.

The inventive compositions may additionally also comprise auxiliaries customary for agrochemical formulations, the selection of the auxiliaries depending on the specific use form, the formulation type or the active ingredient. Examples of suitable auxiliaries are solvents, solid carriers, surfactants (including solubilizers, protective colloids, wetting agents and tackifiers), organic and inorganic thickeners, bactericides, antifreezes, antifoams, optionally adhesives (for example for seed treatment) or customary auxiliaries for bait formulation (e.g. attractants, animal feed, bitter substances).

Useful solvents are water or organic solvents such as mineral oil fractions having a moderate to high boiling point, such as kerosene and diesel oil, and also coal tar oils and oils of vegetable or animal origin, aliphatic, cyclic and aromatic hydrocarbons, for example paraffins, tetrahydronaphthalene, alkylated naphthalenes and derivatives thereof, alkylated benzenes and derivatives thereof, alcohols such as methanol, ethanol, propanol, butanol and cyclohexanol, glycols, ketones such as cyclohexanone, gamma-butyrolactone, dimethyl fatty acid amides, fatty acids and fatty acid esters, and strongly polar solvents, for example amines such as N-methylpyrrolidone. In principle, it is also possible to use solvent mixtures, and also mixtures of the aforementioned solvents and water. The composition preferably comprises water.

Solid carriers are mineral earths such as silicas, silica gels, silicates, talc, kaolin, limestone, lime, chalk, bole, loess, clay, dolomite, diatomaceous earth, calcium sulfate and magnesium sulfate, magnesium oxide, ground plastics, fertilizers such as ammonium sulfate, ammonium phosphate, ammonium nitrate, ureas, and vegetable products such as cereal meal, bark dust, sawdust, nutshell meal, cellulose powder or other solid carriers. The formulation preferably does not comprise any solid carriers.

Useful surfactants (adjuvants, wetting agents, tackifiers, dispersants or emulsifiers) include the alkali metal, alkaline earth metal and ammonium salts of aromatic sulfonic acids, for example of lignosulfonic acid (Borresperse® products, Borregaard, Norway), phenolsulfonic acid, naphthalenesulfonic acid (Morwet® products, Akzo Nobel, USA) and dibutylnaphthalenesulfonic acid (Nekal® products, BASF, Germany), and also of fatty acids, alkyl- and alkylarylsulfonates, alkyl sulfates, lauryl ether sulfates and fatty alcohol sulfates, and also salts of sulfated hexa-, hepta- and octadecanols, and also of fatty alcohol glycol ethers, condensation products of sulfonated naphthalene and derivatives thereof with formaldehyde, condensation products of naphthalene or of the naphthalenesulfonic acids with phenol and formaldehyde, polyoxyethylene octyl phenol ether, ethoxylated isooctylphenol, octylphenol or nonyiphenol, alkylphenyl polyglycol ether, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors, and also proteins, denatured proteins, polysaccharides (e.g. methylcellulose), hydrophobically modified starches, polyvinyl alcohol (Mowiol® products, Clariant, Switzerland), polycarboxylates (Sokalan® products, BASF, Germany), polyalkoxylates, polyvinylamine (Lupamin® products, BASF, Germany), polyethyleneimine (Lupasol® products, BASF, Germany), polyvinylpyrrolidone and copolymers thereof.

Suitable thickeners are compounds which impart modified flow behavior to the formulation, i.e. a high viscosity at rest and low viscosity while mobile. Examples are polysaccharides, proteins (such as casein or gelatin), synthetic polymers, or inorganic layer minerals. Such thickeners are commercially available, for example Xanthan Gum (Kelzan®, CP Kelco, USA), Rhodopol® 23 (Rhodia, France) or Veegum® (R.T. Vanderbilt, USA) or Attaclay® (Engelhard Corp., NJ, USA). The thickener content in the formulation is guided by the efficacy of the thickener. The skilled worker will select such a content that the desired viscosity of the formulation is obtained. The content will usually be 0.01 to 10% by weight.

Bactericides can be added to stabilize the composition. Examples of bactericides are those based on diclorophene and benzyl alcohol hemiformal, and also isothiazolinone derivatives such as alkylisothiazolinones and benzoisothiazolinones (Acticide® MBS from Thor Chemie). Examples of suitable antifreezes are ethylene glycol, propylene glycol, urea and glycerol. Examples of antifoams are silicone emulsions (for example Silikon® SRE, Wacker, Germany or Rhodorsil®, Rhodia, France), long-chain alcohols, fatty acids, salts of fatty acids, organofluorine compounds and mixtures thereof.

Useful adhesives are all customary binders that can be used in seed dressings. Preferred examples include polyvinylpyrrolidone, polyvinyl acetate, polyvinyl alcohol and tylose.

The inventive composition may comprise at least 5% by weight of inorganic salts, preferably at least 10% by weight and especially at least 15% by weight. Suitable inorganic salts are inorganic compounds which comprise anions and cations and which have a solubility in water at 20° C. of at least 10 g/l, preferably at least 50 g/l and especially at least 150 g/l.

In a preferred embodiment, the composition is an aqueous suspension in which at least one pesticide is present in particulate form or in encapsulated form. The suspension comprises preferably 0.0001 to 10% by weight, more preferably 0.0001 to 1% by weight and especially 0.001 to 0.5% by weight of polycarboxylate ether. The aqueous suspension may comprise at least 5% by weight of inorganic salts, preferably at least 10% by weight and especially at least 15% by weight.

In a particularly preferred embodiment, the composition is an agrochemical formulation in the form of a suspension concentrate (SC). The SC comprises typically at least 10% by weight of water, preferably from 20 to 80% by weight. The PCE content may be 0.01 to 10% by weight, preferably 0.05 to 2% by weight and especially 0.05 to 0.8% by weight. At least one pesticide is present in suspended form.

In a particularly preferred embodiment, the composition is an agrochemical formulation in the form of a suspoemulsion (SE). The SE comprises typically at least 10% by weight of water, preferably from 20 to 80% by weight. The PCE content may be 0.01 to 10% by weight, preferably 0.05 to 2% by weight and especially 0.05 to 0.8% by weight. At least one pesticide may be present in suspended form, and a further pesticide may be present in emulsified form.

In a further particularly preferred embodiment, the composition is an agrochemical formulation in the form of a capsule suspension (CS). The CS comprises typically at least 10% by weight of water, preferably from 20 to 80% by weight. The PCE content may be 0.01 to 10% by weight, preferably 0.05 to 2% by weight and especially 0.05 to 0.8% by weight. At least one pesticide may be present in encapsulated form.

In a further preferred embodiment, the composition is a solid composition. The solid composition comprises preferably 0.01 to 20% by weight, more preferably 0.05 to 5% by weight and especially 0.1 to 1.0% by weight of polycarboxylate ether.

In a particularly preferred embodiment, the composition is an agrochemical formulation in the form of water-dispersible granules (WG). The WG is usually a solid. The PCE content may be 0.01 to 20% by weight, preferably 0.05 to 5% by weight and especially 0.1 to 1.0% by weight. At least one pesticide may be in the form of solid particles.

The present invention further relates to a process for producing the inventive composition by contacting the pesticide and the polycarboxylate ether. Customary processes for producing agrochemical formulations are suitable therefor.

The inventive composition is usually diluted before use in order to produce what is known as the tankmix. Useful substances for dilution include mineral oil fractions of moderate to high boiling point, such as kerosene or diesel oil, and also coal tar oils and oils of vegetable or animal origin, aliphatic, cyclic and aromatic hydrocarbons, for example toluene, xylene, paraffin, tetrahydronaphthalene, alkylated naphthalenes or derivatives thereof, methanol, ethanol, propanol, butanol, cyclohexanol, cyclohexanone, isophorone, strongly polar solvents, for example dimethyl sulfoxide, N-methylpyrrolidone or water. Preference is given to using water. The diluted composition is typically applied by spraying or nebulization.

The PCE content in the tankmix is usually less than 0.1% by weight, preferably less than 0.01% by weight and especially less than 0.001% by weight.

The following may be added to the tankmix immediately before use: oils of various types, wetting agents, adjuvants, herbicides, bactericides, fungicides. These compositions can be admixed with the inventive compositions in a weight ratio of 1:100 to 100:1, preferably of 1:10 to 10:1. The pesticide concentration in the tankmix can be varied within relatively wide ranges. It is generally between 0.0001 and 10%, preferably between 0.01 and 1%. According to the type of effect desired, the application rates in the case of use in crop protection are between 0.01 and 2.0 kg of active ingredient per ha.

The present invention further relates to a method of controlling phytopathogenic fungi and/or unwanted plant growth and/or unwanted insect or mite infestation and/or of regulating the growth of plants, wherein the inventive composition is allowed to act on the particular pests, the surroundings thereof or the plants to be protected from the particular pest, the soil and/or on unwanted plants and/or the crop plants and/or the surroundings thereof.

The present invention further relates to seed comprising the inventive composition.

The present invention further relates to the use of the polycarboxylate ether for dispersion of pesticides having a solubility in water of at most 10 g/l in aqueous compositions. The pesticide is preferably present in suspended form in the aqueous composition, i.e. in the form of crystalline or amorphous particles which are solid at 20° C. The PCE content in the aqueous composition is usually less than 0.1% by weight, preferably less than 0.01% by weight and especially less than 0.001% by weight.

In one embodiment of the present invention, the method is for dressing seed, wherein
(a) seed is treated with a pesticide having a solubility in water of not more than 10 g/l and the polycarboxylate ether; and
(b) the seed obtained in step (a) is optionally dried.

The polycarboxylate ether can be used as described above or in the form of the inventive composition. It is possible here—if desired—to dilute the inventive composition or the polycarboxylate ether with a solvent, preferably water, before application to the seed.

This seed pretreated in this way can subsequently be treated with an agrochemical suspension formulation comprising at least one active agrochemical ingredient suitable for dressing of seed, in which case the active ingredient is present in solid particles having a size between 0.1 μm and 10 μm.

These agrochemical formulations are suspension formulations of one (or more than one) active agrochemical ingredient (for example SC, OD, FS), in which case the active ingredient must have the particle sizes stated above. The production of suspension formulations is known to those skilled in the art, and is explained above.

Alternatively, the active ingredient suspension can also be produced from a solid formulation (possibly even commercially available) of an active ingredient by dispersion in a solvent, preferably water (see above).

The term “seed” comprises seed of all kinds, for example grains, seeds, fruits, tubers, seedlings and similar forms. The term “seed” here preferably describes grains and seeds.

Suitable seeds are cereal seeds, grain crop seeds, root crop seeds, oil seeds, vegetable seeds, spice seeds or ornamental plant seed material, e.g. seed material from hard wheat, wheat, barley, oats, rye, corn (fodder corn and sweet corn), soybean, oil seeds, crucifers, cotton, sunflowers, bananas, rice, rape, turnips, sugar beet, fodder beet, egg plants, potatoes, grass, (cultivated) lawns, fodder grass, tomatoes, leeks, pumpkins, cabbage, iceberg lettuce, peppers, cucumbers, melons, Brassica species, melons, beans, peas, garlic, onions, carrots, sugarcane, tobacco, grapes, petunias and geraniums, pansies, touch-me-not. The term “seed” here preferably describes cereal and soybeans.

The inventive compositions can be used for dressing seed of plants obtained by conventional breeding methods, and for dressing seed from transgenic plants.

As already mentioned, it is possible to use seed which is tolerant to herbicides, for example plants resistant to sulfonylureas, imidazolinones or glufonsinate or glyphosate (see, for example, EP-A-0242236, EP-A-242246) (WO 92/00377) (EP-A-0257993, U.S. Pat. No. 5,013,659) or seed of transgenic plants, for example cotton, which produce Bacillus thuringiensis toxin (Bt toxins) and as a result are resistant to particular harmful organisms (EP-A-0142924, EP-A-0193259).

In addition, it is also possible to use seed from plants which have modified properties compared with conventional plants. Examples thereof are altered starch synthesis (e.g. WO 92/11376, WO 92/14827, WO 91/19806) or fatty acid compositions (WO 91/13972).

The term “plants” also includes those plants which have been modified by breeding, mutagenesis or genetic methods, including the biotechnological agricultural products on the market or being developed. Genetically modified plants are plants whose genetic material has been modified in a manner which does not occur under natural conditions, by crossing, mutation or by natural recombination (i.e. a recombination of the genetic information). In general, one or more genes are integrated into the genetic material of the plant, in order to improve the properties of the plant. Such modifications by genetic engineering include post-translational modifications of proteins, oligopeptides or polypeptides, for example by glycosylation or attachment of polymers, for example prenylated, acetylated or farnesylated residues or PEG residues. Examples include plants which, by virtue of breeding and genetic engineering methods, have acquired tolerance to particular herbicide classes, such as auxin herbicides, for example dicamba or 2,4-D, bleaching herbicides such as hydroxyphenylpyruvate dioxy-genase (HPPD) inhibitors or phytoendesaturase (PDS) inhibitors, acetolactate synthase (ALS) inhibitors, for example sulfonylureas, enolpyruvylshikimate 3-phosphate synthase (EPSPS) inhibitors, for example glyphosate, glutamine synthetase (GS) inhibitors, for example glufosinate, lipid biosynthesis inhibitors, for example acetyl CoA carboxylase (ACCase) inhibitors, or oxynil herbicides (e.g. bromoxynil or ioxynil). In addition, plants resistant to two or more herbicide classes by virtue of several genetic engineering measures have been obtained, for example resistant to glyphosate and glufosinate, or to glyphosate and a herbicide of another class, for example ALS inhibitors, HPPD inhibitors, auxin herbicides and ACCase inhibitors. These herbicide resistance technologies are described, for example, in Pest Managem. Sci. 61, 2005, 246; 61, 2005, 258; 61, 2005, 277; 61, 2005, 269; 61, 2005, 286; 64, 2008, 326; 64, 2008, 332; Weed Sci. 57, 2009, 108; Austral. J. Agricult. Res. 58, 2007, 708; Science 316, 2007, 1185; and references cited therein. Breeding and mutagenesis have been used to obtain, for example, Clearfield® oilseed rape (BASF SE, Germany), which is tolerant to imidazolinones, for example imazamox, and ExpressSun® sunflowers (DuPont, USA), which are tolerant to sulfonylurea herbicides, for example tribenuron. Genetic engineering methods have been used to obtain crop plants such as soybeans, cotton, corn, beet and oilseed rape which are resistant to glyphosate or glufosinate, and which are obtainable under the trade names RoundupReady® (glyphosate-resistant, Monsanto, U.S.A.), Cultivance® (imidazolinone-resistant, BASF SE, Germany) and Liberty Link® (glufosinate-resistant, Bayer CropScience, Germany).

In addition, also included are plants which, owing to genetic engineering measures, produce one or more toxins, for example those of the Bacillus bacterial strain. Toxins which are produced by such genetically modified plants include, for example, insecticidal proteins of Bacillus spp., especially of B. thuringiensis, such as the endotoxins Cry1Ab, Cry1Ac, Cry1F, Cry1Fa2, Cry2Ab, Cry3A, Cry3Bb1, Cry9c, Cry34Ab1 or Cry35Ab1; or vegetative insecticidal proteins (VIPs), for example VIP1, VIP2, VIP3, or VIP3A; insecticidal proteins of nematode-colonizing bacteria, for example Photorhabdus spp. or Xenorhabdus spp.; toxins from animal organisms, for example wasp, spider or scorpion toxins; fungal toxins, for example from Streptomycetes; plant lectins, for example from peas or barley; agglutinins; proteinase inhibitors, for example trypsin inhibitors, serine protease inhibitors, patatin, cystatin or papain inhibitors; ribosome-inactivating proteins (RIPs), for example ricin, corn-RIP, abrin, luffin, saporin or bryodin; steroid-metabolizing enzymes, for example 3-hydroxysteroid oxidase, ecdysteroid-IDP glycosyl transferase, cholesterol oxidase, ecdyson inhibitors, or HMG-CoA reductase; ion channel blockers, for example inhibitors of sodium channels or calcium channels; juvenile hormone esterase; receptors of the diuretic hormone (helicokinin receptors); stilbene synthase, bibenzyl synthase, chitinases and glucanases. In the plants, these toxins may also be produced as pretoxins, hybrid proteins or truncated or otherwise modified proteins. Hybrid proteins are characterized by a novel combination of different protein domains (see, for example, WO 2002/015701). Further examples of such toxins or genetically modified plants which produce these toxins are disclosed in EP-A 374 753, WO 93/07278, WO 95/34656, EP-A 427 529, EP-A 451 878, WO 03/18810 and WO 03/52073. The methods for producing these genetically modified plants are known to the person skilled in the art and disclosed, for example, in the publications mentioned above. Many of the toxins mentioned above impart to the plants that produce them tolerance to pests from all taxonomic classes of arthropods, in particular to beetles (Coeleropta), dipterans (Diptera) and butterflies (Lepidoptera) and to nematodes (Nematoda). Genetically modified plants which produce one or more genes encoding insecticidal toxins are described, for example, in the publications mentioned above, and some of them are commercially available, for example YieldGard® (corn varieties which produce the toxin Cry1Ab), YieldGard® Plus (corn varieties which produce the toxins Cry1Ab and Cry3Bb1), Starlink® (corn varieties which produce the toxin Cry9c), Herculex® RW (corn varieties which produce the toxins Cry34Ab1, Cry35Ab1 and the enzyme phosphinothricin N-acetyltransferase [PAT]); NuCOTN® 33B (cotton varieties which produce the toxin Cry1Ac), Bollgard® I (cotton varieties which produce the toxin Cry1Ac), Bollgard® II (cotton varieties which produce the toxins Cry1Ac and Cry2Ab2); VIPCOT® (cotton varieties which produce a VIP toxin); NewLeaf® (potato varieties which produce the toxin Cry3A); Bt-Xtra®, NatureGard®, KnockOut®, BiteGard®, Protecta®, Bt11 (for example Agrisure® CB) and Bt176 from Syngenta Seeds SAS, France (corn varieties which produce the toxin Cry1Ab and the PAT enzyme), MIR604 from Syngenta Seeds SAS, France (corn varieties which produce a modified version of the toxin Cry3A, see WO 03/018810), MON 863 from Monsanto Europe S.A., Belgium (corn varieties which produce the toxin Cry3Bb1), IPC 531 from Monsanto Europe S.A., Belgium (cotton varieties which produce a modified version of the toxin Cry1Ac) and 1507 from Pioneer Overseas Corporation, Belgium (corn varieties which produce the toxin Cryl F and the PAT enzyme).

In addition, also included are plants which, owing to genetic engineering measures, produce one or more proteins which have increased resistance to bacterial, viral or fungal pathogens, for example pathogenesis-related proteins (PR proteins, see EP-A 0 392 225), resistance proteins (for example potato varieties producing two resistance genes against Phytophthora infestans from the wild Mexican potato Solanum bulbocastanum) or T4 lysozyme (for example potato varieties which, by producing this protein, are resistant to bacteria such as Erwinia amylvora). In addition, also included are plants whose productivity has been improved with the aid of genetic engineering methods, for example by enhancing the potential yield (for example biomass, grain yield, starch, oil or protein content), tolerance to drought, salt or other limiting environmental factors or resistance to pests and fungal, bacterial and viral pathogens. In addition, also included are plants whose ingredients have been modified with the aid of genetic engineering methods, in particular for improving human or animal diet, for example by virtue of oil plants producing health-promoting long-chain omega-3 fatty acids or monounsaturated omega-9 fatty acids (for example Nexera® oilseed rape, DOW Agro Sciences, Canada). In addition, also included are plants which have been modified with the aid of genetic engineering methods for improved production of raw materials, for example by increasing the amylopectin content of potatoes (Amflora® potato, BASF SE, Germany).

Also claimed in the context of the present invention is seed which comprises an inventive composition.

The application rates are generally between 0.1 g-10 kg of active ingredient per 100 kg of seed, preferably 1 g to 5 kg, more preferably 1 g-2.5 kg. For specific seed such as lettuce, the application rates may also be higher. For soybeans, application rates of 0.1-10 kg are used.

The seed treatment can be performed by methods known to those skilled in the art, by spraying the seed with the formulation or mixing the seed with the formulation, optionally followed by drying of the seed before sowing and before germination.

The present invention further comprises a method of regulating the growth of plants and/or of controlling unwanted plant growth and/or of controlling unwanted insect or mite infestation on plants and/or of controlling phytopathogenic fungi, wherein seed of crop plants is treated treated with a pesticide having a solubility in water of at most 10 g/l and the polycarboxylate ether.

The invention preferably comprises methods of controlling unwanted insect or mite infestation on plants and/or of controlling phytopathogenic fungi, wherein seed of crop plants is treated treated with a pesticide having a solubility in water of not more than 10 g/l and the polycarboxylate ether. The polycarboxylate ether can be used as described above or in the form of the inventive composition.

The advantages of the invention are that a high dispersion stability can be achieved with only relatively small amounts of the inventive dispersant. This is especially true in the case of formulations which comprise high concentrations of pesticide. The inventive dispersants also stabilize highly concentrated solid formulations after dilution with water. In the case of suspensions (in particular suspension concentrates), small added amounts of inventive dispersant reduce serum formation, and increase storage stability. A further advantage is that a high level of dispersion stability can be achieved even with relatively small amounts of the inventive dispersant, not least for formulations (including aqueous formulations) having a high salt content.

The examples which follow illustrate the invention without restricting it.

### EXAMPLES

Flexity®: an aqueous suspension concentrate comprising 25.2% by weight of metrafenone and additives such as alkylpolysaccharide and sodium alkylnaphthalenesulfonate-formaldehyde condensate, pH about 7, surface tension 31 mN/m (20° C.), dynamic viscosity 616 mPa·s (20° C., 100 1/s), commercially available from BASF SE.
Glenium® ACE 430: inventive polycarboxylate ether, liquid with solids content about 30% by weight, pH 5.5+/−1 at 20° C., commercially available from BASF Construction Polymers GmbH.
Glenium® B233: inventive polycarboxylate ether, water-soluble liquid with solids content >30% by weight, pH about 7 at 20° C., commercially available from BASF Construction Polymers GmbH.
Glenium® 3400 NV: inventive polycarboxylate ether, water-soluble liquid with solids content >30% by weight, pH about 7.8 at 20° C., commercially available from BASF Construction Polymers GmbH.
Glenium® ACE 30: inventive polycarboxylate ether, water-soluble liquid with solids content about 30% by weight, pH 6.5+/−1.5 at 20° C., commercially available from BASF Construction Polymers GmbH.

### Example 1

### Dispersion Stability

The Flexity® suspension concentrate (SC) was admixed with 1, 10 or 25 g/l polycarboxylate ether (PCE) or, as a control, stored without polycarboxylate ether. The dispersion stability was determined directly after addition (“initial”) of the polycarboxylate ether, and after storage at 54° C. for 14 days (“stored”).

The dispersion stability was determined to CIPAC MT180 in a graduated pointed cylinder which had been charged with 100 ml of water (19.2° dH). After addition of 1 ml of suspension concentrate, the mixture is completely dispersed and then left to stand. The sediment volume is read off after 120 min (table 1).

TABLE 1

| | PCE | PCE in | Sediment | Sediment |
|---|---|---|---|---|
| PCE | in SC | dispersion | [ml] initial | [ml] stored |
| none | — | — | 0.1 | 0.5 |
| Glenium ® B233 | 1 g/L | 0.01 g/L | <0.05 | <0.05 |
| Glenium ® 3400 NV | 1 g/L | 0.01 g/L | <0.05 | <0.05 |
| Glenium ® 3400 NV | 10 g/L | 0.1 g/L | <0.05 | <0.05 |
| Glenium ® 3400 NV | 25 g/L | 0.25 g/L | <0.05 | <0.05 |
| Glenium ® ACE 30 | 1 g/L | 0.01 g/L | <0.05 | <0.05 |
| Glenium ® ACE 430 | 1 g/L | 0.01 g/L | <0.05 | <0.05 |

### Example 2

### Dispersion Stability of Granules After Dispersion

A granule formulation comprising 75% by weight of tritosulfuron was admixed with 0.25% by weight (2.5 g/kg) of polycarboxylate ether.

The sediment volume was determined in a graduated pointed cylinder which had been charged with 100 ml of water (19.2° dH). After addition of 0.2 g or 2 g of granules, the mixture is completely dispersed and then left to stand. The sediment volume is read off after 30 min. As a control, a formulation without polycarboxylate ether was also stored. The results are compiled in tables 2 and 3.

TABLE 2
Dispersion stability

| | Granules | | | |
|---|---|---|---|---|
| | in | PCE in | Sediment | Sediment |
| PCE | dispersion | dispersion | [ml] initial | [ml] stored |
| none | 2 g/l | — | 0.2 ml | <0.25 ml |
| Glenium ® ACE 430 | 2 g/l | 0.005 g/l | <0.05 ml | <0.15 ml |
| Glenium ® ACE 30 | 2 g/l | 0.005 g/l | 0.15 ml | <0.2 ml |
| none | 20 g/l | — | 2 ml | 5 ml |
| Glenium ® ACE 430 | 20 g/l | 0.05 g/l | 0.6 ml | 0.65 ml |
| Glenium ® ACE 30 | 20 g/l | 0.05 g/l | 0.75 ml | 0.6 ml |

TABLE 3

| | Dispersibility | Dispersibility |
|---|---|---|
| PCE | initial [%] | stored [%] |
| none | 90% | 87% |
| Glenium ® ACE 430 | 97% | 96% |
| Glenium ® ACE 30 | 94% | 94% |

### Example 3

### Storage Stability of Suspension Concentrates

The Flexity® suspension concentrate was admixed with 1 g/l polycarboxylate ether or, as a control, stored without polycarboxylate ether. The storage stability with respect to sedimentation was determined after storage at 54° C. for 14 days. The supernatant liquid (serum formation) was determined by visual assessment (table 4).

TABLE 4

| | Amount of | Serum formation |
|---|---|---|
| PCE | PCE | stored [%] |
| none | — | 6% |
| Glenium ® B233 | 1 g/L | 4.1% |
| Glenium ® 3400 NV | 1 g/L | 4.2% |

### Example 4

### Highly Concentrated Suspensions for Seed Treatment

5 g of each dispersant to be tested were added to 200 ml of water, and 800 g of solid calcium carbonate were stirred into each (table 5). The comparative test with the commercial dispersant Ufoxan 3A (a sodium lignosulfonate CAS 8061-51-6, from Borregard Lignoech) did not lead to a free-flowing consistency.

TABLE 5

| Mixture | Dispersant | Consistency |
|---|---|---|
| comparative | Ufoxane ® 3A | pasty, not free-flowing |
| 1 | Glenium ® B233 | mobile |
| 2 | Glenium ® ACE 30 | mobile |

Suspension 1 according to table 5 was mixed in equal parts (1:1:1) with the commercially available seed treatment product Rubin® TT (aqueous suspension concentrate comprising 42 g/l pyrimethanil, 25 g/l triticonazole and 38.6 g/l prochloraz, available from BASF SE) and with water. 6 ml of this mixture were applied to 1 kg of wheat in a commercial Rotostat laboratory seed dresser.

### Example 5

### Dispersion Stability at High Salt Concentration

An aqueous suspension concentrate (SC) comprising 300 g/l mepiquat chloride, 50 g/l prohexadione-calcium, 200 g/l ammonium nitrate, 150 g/l nonionic surfactant, and also further auxiliaries (such as thickeners, antifoams) was prepared in the same way as for reference example 2 in EP1339284B1. The SC was stored with 5, 10, 25 or 50 g/l polycarboxylate ether (PCE) admixed or stored, as a control, without polycarboxylate ether. The PCE used was Glenium® B233, Glenium® 3400 NV, Glenium® ACE 30, or Glenium® ACE 430.

The dispersion stability (as a 2.0% dispersion) was determined as described in example 1 after 14-day storage at 10° C. In the case of the control sample without PCE, 0.5 ml of sediment was found. All samples to which a PCE had been added in one of the stated concentrations contained less than 0.05 ml of sediment. Even at high salt concentrations, the PCE allowed a relatively high stability to be achieved during storage of the dispersion.

### Example 6

### Dispersion Stability

An aqueous suspension concentrate (SC) comprising 29% by weight pyraclostrobin, 3.5% by weight dispersant, 3.5% by weight polyalkylene oxide block copolymer, 0.3% by weight xanthan gum, and further auxiliaries was stored at −10° C. or at 50° C. for two weeks. The particle size was measured and the increase calculated on the basis of the storage at −10° C.

Dispersants used were Glenium® B233, Glenium® 3400 NV, Glenium® ACE 30, or Glenium® ACE 430, and also, as a control, Atlox® 4913 (available commercially from Uniqema; comprises a reaction product of methyl methacrylate, methacrylic acid, and methoxy-PEG methacrylate) or Soprophor® BSU (available commercially from Rhodia; comprises ethoxylated (16 EO) tristyrylphenol, CAS 99734-09-5).

TABLE 7

| | Storage | Particle size | Increase |
|---|---|---|---|
| Dispersant | temperature | D(0.5) [μm] | [%] |
| Atlox ® 4913^{a)} | −10° C. | 1.62 | 0% |
| | +50° C. | 2.78 | 72% |
| Soprophor ® BSU^{a)} | −10° C. | 1.76 | 0% |
| | +50° C. | 6.74 | 282% |
| Glenium ® ACE 430 | −10° C. | 1.75 | 0% |
| | +50° C. | 2.92 | 66% |
| Glenium ® 3400 NV | −10° C. | 1.81 | 0% |
| | +50° C. | 2.88 | 59% |
| Glenium ® ACE 30 | −10° C. | 1.89 | 0% |
| | +50° C. | 2.93 | 55% |
| Glenium ® B233 | −10° C. | 1.79 | 0% |
| | +50° C. | 2.84 | 59% |

^{a)}not inventive

1-15. (canceled)

16. A composition comprising a pesticide having a solubility in water of at most 10 g/1 and a polycarboxylate ether based on
a) component groups of the formula Ia and/or Ib and/or Ic 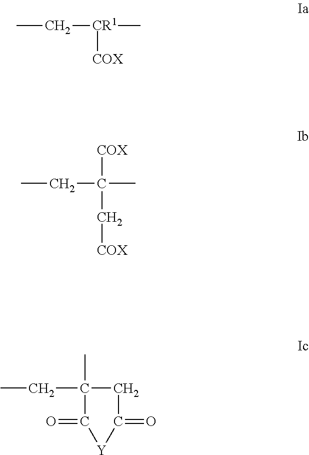
where R¹=hydrogen or an aliphatic hydrocarbon radical having 1 to 20 carbon atoms,
X═—OMₐ, —O—(CₘH₂ₘO)ₙ—R², or —NH—(CₘH₂ₘO)ₙR^{2,}
M=hydrogen, a mono- or divalent metal cation, an ammonium ion, or an organic amine radical,
a=½ or 1,
R²=hydrogen, an aliphatic hydrocarbon radical having 1 to 20 carbon atoms, a cycloaliphatic hydrocarbon radical having 5 to 8 carbon atoms, or an optionally substituted aryl radical having 6 to 14 carbon atoms,
Y═O or NR²,
m=2 to 4, and
n=0 to 200,
and
b) component groups of the general formula II 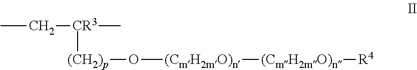
where R³=hydrogen or an aliphatic hydrocarbon radical having 1 to 5 carbon atoms,
n′,n″=each independently 0 to 200,
m′,m″=each independently 2 to 4,
n′+n″=1 to 200,
p=0 to 3, and
R⁴=hydrogen, an aliphatic hydrocarbon radical having 1 to 20 carbon atoms, a cycloaliphatic hydrocarbon radical having 5 to 8 carbon atoms, or an optionally substituted aryl radical having 6 to 14 carbon atoms.

17. The composition according to claim 16, wherein the polycarboxylate ether comprises 55 to 75 mol % of component groups of the formula Ia and/or Ib, and 19.5 to 39.5 mol % of component groups of the formula II.

18. The composition according to claim 16, wherein the polycarboxylate ether comprises up to 50 mol % of comonomers, based on the sum of component groups a) and b), and wherein the comonomers are selected from vinyl- and (meth)acrylic acid derivatives; and wherein said vinyl- or (meth)acrylic acid derivative is styrene, α-methylstyrene, vinyl acetate, vinyl propionate, ethylene, propylene, isobutene, hydroxyalkyl (meth)acrylates, acrylamide, methacrylamide, N-vinylpyrrolidone, allylsulfonic acid, methallylsulfonic acid, vinylsulfonic acid, vinylphosphonic acid, AMPS, methyl methacrylate, methyl acrylate, butyl acrylate, or allylhexyl acrylate.

19. The composition according to claim 16, wherein the composition comprises at least 5% by weight of an inorganic salt.

20. The composition according to claim 16, wherein the polycarboxylate ether is free of vinylaromatic monomers.

21. The composition according to claim 16, wherein the composition is an aqueous suspension in which at least one pesticide is present in particulate form or in encapsulated form.

22. The composition according to claim 16, wherein the composition is an aqueous suspension which comprises 0.001 to 10% by weight of polycarboxylate ether.

23. The composition according to claim 16, wherein the composition is a solid composition.

24. The composition according to claim 16, wherein the composition is a solid composition which comprises 1.0 to 5.0% by weight of polycarboxylate ether.

25. A process for producing the composition according to claim 16, comprising contacting the pesticide with the polycarboxylate ether.

26. A method of controlling phytopathogenic fungi and/or unwanted plant growth and/or unwanted insect or mite infestation and/or of regulating the growth of plants, wherein the composition according to claim 16 is allowed to act on the particular pests, the surroundings thereof or the plants to be protected from the particular pest, the soil and/or on unwanted plants and/or the crop plants and/or the surroundings thereof

27. The method of claim 26, wherein the polycarboxylate ether comprises 55 to 75 mol % of component groups of the formula Ia and/or Ib, and 19.5 to 39.5 mol % of component groups of the formula II.

28. The method of claim 26, wherein the polycarboxylate ether comprises up to 50 mol % of comonomers, based on the sum of component groups a) and b), and wherein the comonomers are selected from vinyl- and (meth)acrylic acid derivatives; and wherein said vinyl- or (meth)acrylic acid derivative is styrene, α-methylstyrene, vinyl acetate, vinyl propionate, ethylene, propylene, isobutene, hydroxyalkyl (meth)acrylates, acrylamide, methacrylamide, N-vinylpyrrolidone, allylsulfonic acid, methallylsulfonic acid, vinylsulfonic acid, vinylphosphonic acid, AMPS, methyl methacrylate, methyl acrylate, butyl acrylate, or allylhexyl acrylate.

29. The method of claim 26, wherein the composition comprises at least 5% by weight of an inorganic salt.

30. The method of claim 26, wherein the polycarboxylate ether is free of vinylaromatic monomers.

31. The method of claim 26, wherein the composition is an aqueous suspension in which at least one pesticide is present in particulate form or in encapsulated form.

32. The method of claim 26, wherein the composition is an aqueous suspension which comprises 0.001 to 10% by weight of polycarboxylate ether.

33. A seed treated with the composition according to claim 16.

34. A method of dressing seed, wherein
(a) the seed is treated with to the composition of claim 16; and
(b) the seed obtained in step (a) is optionally dried.

35. A method of controlling unwanted insect or mite infestation on plants and/or of controlling phytopathogenic fungi, wherein seed of crop plants is treated with a pesticide having a solubility in water of not more than 10 g/l and the polycarboxylate ether according to claim 16.
